(19) United States
(12) Patent Application Publication
(10) Pub. No.: US 2010/0275631 A1
(43) Pub. Date: Nov. 4, 2010

(54) REFRIGERATOR UNIT AND/OR FREEZER UNIT

(76) Inventors: Matthias Wiest, Ochsenhausen (DE); Eugen Sättele, Alleshausen (DE); Helmuth Bauer, Gaimberg (AT)

Correspondence Address: DILWORTH & BARRESE, LLP, 1000 WOODBURY ROAD, SUITE 405, WOODBURY, NY, 11797, US

(21) Appl. No.: 12/810,605

(22) PCT Filed: Dec. 2, 2008
(86) PCT No.: PCT/EP2008/010202

§ 371 Date: Jun. 25, 2010

(30) Foreign Application Priority Data
Dec. 27, 2007 (DE) 20 2007 018 059.4
Jan. 25, 2008 (DE) 20 2008 001 118.3

(51) Int. Cl. F25D 21/08; H05B 1/02

(52) U.S. Cl. 62/275; 219/494

(57) ABSTRACT

The present invention relates to a refrigerator unit and/or a freezer unit comprising at least one heating device for the avoidance of condensate formation, characterized in that the heating device is a heating device which is not foamed in and which is arranged on or in the region of at least one outer side of the unit.

The present invention relates to a refrigerator unit and/or a freezer unit having a heating device for the avoidance of condensation formation.

On the installation of refrigerator units and/or freezer units next to one another or on the installation of such units directly at a piece of furniture or at a building wall or the like, there is a problem in that condensation formation can occur between the units or in the region between the unit and the wall of the piece of furniture or the building wall.

It is known from the prior art to avoid condensation formation in that heating devices are foamed in at at least one side wall and/or at the door frame of the unit. These heating devices are, for example, electric heaters which bring along the disadvantage of comparatively high energy consumption. Foamed in heating devices in the form of foamed in pipe lines are furthermore known from the prior art through which compressed refrigerant flows. The compressed refrigerant emits the waste heat of the refrigerant circuit of the unit and in this way heats the respective surface, whereby the undesired condensation formation is prevented.

A disadvantage of these known heating devices lies in the fact that refrigerant lines are expensive and are moreover very complex in processing. Pressure spots can, for example, occur at the outer surface. A further disadvantage lies in the fact that the energy consumption and thus the energy costs are comparatively high, that local overheating can occur and that an influence on the inner temperature of the unit can occur under certain circumstances.

Further disadvantages of the aforesaid foamed heating devices lie in the fact that these additional costs induced thereby naturally also occur in units which are not installed side-by-side with another unit or directly adjacent to a wall, i.e. in units in which no heating device would be necessary to avoid condensate formation. Since the later installation location of the unit is not known in the manufacturing process of the unit, the heating devices have to be foamed in on both sides of the unit, which results in a corresponding increase in cost of the units.

It is therefore the underlying object of the present invention to further develop a unit of the initially named kind such that the condensate formation can be avoided in a simple manner and comparatively cost-effectively.

This object is achieved by a refrigerator unit and/or a freezer unit having the features of claim 1.

Provision is accordingly made that the heating device is designed such that it is attached or can be attached to or in the region of at least one outer side, preferably at or in the region of one or both side walls of the unit, with the heating device not being foamed in in accordance with the invention, which enables its more flexible use. The heating device in accordance with the invention is preferably a component of a modular kit, preferably a retrofittable modular kit which is only attached in units in which there is a risk of condensate formation. A substantial cost reduction can be achieved in this manner since it is not necessary to equip all units with such a heating device.

The term “at or in the region of the outer side” is to be understood such that the heating device is arranged such that the outer side of the unit can be heated by the heating device. In this respect, the heating device can be arranged directly or indirectly on the inner side and/or outer side of the unit housing, for example.

Provision is made in a preferred embodiment of the invention that the heating device is an electric heater.

The use of extremely flat heating films is conceivable, for example, since they permit a very small spacing of the units from one another or a very small spacing of the unit from a wall or the like.

Provision is made in a further embodiment of the invention that the heating device is a film heater with heating wires welded on.

It is also possible to use a tubular heater which can be fastened between two units or between the unit and a wall in any desired manner or which can be fixed by clamps.

If heaters of larger thickness are used, a cover for the gap between the units or between the unit and the wall can be provided for visual reasons. In this respect, it can be a panel which covers the gap and thus also the heating device.

It is furthermore conceivable that the heating device(s) is/are suspended in the region in question.

If a connector element is provided which connects two units standing next to one another to one another or a unit to an adjacent wall or the like, provision can be made that the at least one heating device is arranged, in particular suspended, at this connector element. The heating device can also be arranged, in particular suspended, at a cover element which covers the gap between two units or between a unit and an adjacent wall or the like on the upper side and/or at the front side.

Provision is made in a preferred embodiment that the heating device is fixed to the unit by an adhesive connection. It is conceivable that a film heater is adhesively bonded to the side wall of a unit or also to the wall or a further unit wall adjacent to the unit.

The heating device in accordance with the present invention can be arranged at the outer side of the unit. However, the case is also covered by the invention that the heating device is not arranged directly at the outer side, but rather in the region of the outer side, which is e.g. the case when the heating device is arranged at the wall or unit wall which is adjacent to the unit.

In a further embodiment of the present invention, the unit has a connection for the heating device and/or a mount for a control or regulation device for the heating device. In this respect, the connection and/or the mount is/are preferably designed such that a retrofitting is possible. The use of a modular kit is thus conceivable having a heating device and/or the named control or regulation unit and optionally one or more sensors, preferably for temperature and/or humidity, with the modular kit preferably being able to be retrofitted simply and fast.

The refrigerator unit and/or freezer unit can have a control or regulation device for the control or regulation of the heating device, with the control or regulation device being able to be designed such that it operates the heating device permanently and, for example, at a constant power. It is thus conceivable that the heating device runs as soon as the unit is put into operation. To avoid an improper heating of the unit, the heating power is to be adjusted in a suitable manner to the surface on which it has an effect.

It is likewise possible that the control or regulation device is designed such that it operates the heating device in dependence on one or more parameters.

The parameter can, for example, be the temperature at or in the region of at least one outer side of the unit. It is, for example, possible to measure the temperature at or in the region of the unit outer side, for example at the unit surface, or also in the region between two units or between a unit and an adjacent wall or the like via a mechanical or electric thermostat. The heating device can then be switched on and off or its power set in dependence on this measured value.

The parameter can, for example, also be the difference from the temperature at or in the region of at least one outer side of the unit and of the environmental temperature. A particularly exact and energy-saving heating can be provided by a comparison of the temperature of the environmental atmosphere of the unit with the temperature at or in the region of the housing outer side, for example with the surface temperature.

Alternatively or additionally to the parameter “temperature”, the parameter “humidity” can be used to regulate or control the heating device. It is conceivable to use a humidity sensor to measure the air humidity at or in the region of at least one outer side of the unit and/or the moisture of the environmental air and to carry out a control or regulation of the heating device on this basis. This procedure also allows an energy-optimized manner of use of the heating device.

The present invention furthermore relates to an arrangement comprising at least one refrigerator unit and/or freezer unit and comprising at least one heating device, wherein the arrangement is characterized in that the heating device is arranged in the region of at least one outer side of the unit. The heating device thus does not necessarily have to be a component of the refrigerator unit and/or freezer unit, but can rather also be fixed to a wall, for example, to which the refrigerator unit and/or freezer unit is adjacent and/or can have an energy supply and/or control or regulation independent of the unit.

The heating device can be arranged, for example, in the region of one or both side walls of the unit.

The heating device can be a component of a modular kit which can be attached in the region of the unit. It is conceivable to design the modular kit as a retrofittable modular kit.

The refrigerator unit and/or freezer unit in accordance with the invention is preferably made in accordance with the characterizing portion of one of the claims 4 to 16.

Further details of the present invention will be explained in more detail with respect to an embodiment described in the following.

The embodiment relates to an arrangement having two refrigerator units and/or freezer units installed next to one another or an arrangement comprising a refrigerator unit and/or freezer unit which is installed next to a wall of a piece of furniture or a building wall.

To prevent the condensate formation in the region between the two units or between the unit and a wall, a film heater is adhesively bonded to the side wall of the unit directed to the adjacent unit or to the wall. The film heater is located on the outer side of the side wall. Due to its low thickness, the gap to the adjacent unit or to the wall can be selected as very small.

The unit furthermore has a control or regulation device by means of which the heating device can be controlled/regulated. The unit furthermore has at least one temperature sensor and/or at least one humidity sensor, with the temperature sensor being arranged such that it measures the temperature in the gap to the adjacent unit or to the wall and/or at the surface of the outer side of the unit. The humidity sensor can be arranged such that it determines the humidity of the environmental air.

If it is found that the temperature is, for example, comparatively low and/or the air humidity is comparatively high at the unit surface, provision can be made that the control or regulation device operates the heating device with a higher power or increases the relative switch-on time, i.e. the ratio of operating times and times in which the heating device is out of operation. The condensate formation can be prevented effectively and in an energy optimized manner in this way.

The heating device in accordance with the present embodiment is a retrofittable modular kit. To be able to connect the heating device to the unit without problem, it is made with a corresponding plug apparatus. Furthermore, the unit has a mount into which the control or regulation device can be introduced which serves the control or regulation of the heating device. Mounts can also be provided for one or more sensors which serve the temperature measurement and/or the measurement of the air humidity. The connection of the control or regulation device and/or of the sensor or sensors can likewise take place, for example, by a plug connection by which the mechanical fixing and the electric connection are provided.

The possibility is opened up by the present invention that not all units have to be designed with a heating device for the avoidance of condensate formation ex works, but rather only the units in which, perhaps due to their installation location, a condensate formation is to be expected. Added costs and added effort are therefore only effective in these units and not in all units.

1. A refrigerator unit and/or a freezer unit comprising at least one heating device for the avoidance of condensate formation, wherein the heating device is a heating device which is not foamed in and which is arranged on or in the region of at least one outer side of the unit.

2. A refrigerator unit and/or a freezer unit in accordance with claim 1, wherein the heating device is arranged at or in the region of one of both side walls of the unit.

3. A refrigerator unit and/or a freezer unit in accordance with claim 1, the heating device is a component of a modular kit which can be attached to or in the region of at least one outer side of the unit, preferably subsequently.

4. A refrigerator unit and/or a freezer unit in accordance with claim 1, wherein the heating device is an electric heater.

5. A refrigerator unit and/or a freezer unit in accordance with claim 1, wherein the heating device is a heating film.

6. A refrigerator unit and/or a freezer unit in accordance with claim 1, wherein the heating device is a film heater having heating wires preferably welded on.

7. A refrigerator unit and/or a freezer unit in accordance with claim 1, wherein the heating device is a tubular heater.

8. A refrigerator unit and/or a freezer unit in accordance with claim 1, wherein the heating device is fixed to or in the region of at least one outer side of the unit; or the heating device is clamped between two adjacent unit outer sides or between a unit outer side and a wall adjacent thereto or the like.

9. A refrigerator unit and/or a freezer unit in accordance with claim 1, wherein the heating device is suspended.

10. A refrigerator unit and/or a freezer unit in accordance with claim 1, wherein the heating device is fixed to at least one of the outer sides of the unit by an adhesive bond.

11. A refrigerator unit and/or a freezer unit in accordance with claim 1, wherein the unit has at least one connection for the heating device and/or at least one mount for a control or regulation device for the heating device.

12. A refrigerator unit and/or a freezer unit in accordance with claim 1, wherein a control or regulation device is provided for the control or regulation of the heating device, with the control or regulation device being designed such that it operates the heating device permanently, preferably with a constant power.

13. A refrigerator unit and/or a freezer unit in accordance with claim 1, wherein a control or regulation device is provided for the control or regulation of the heating device, with the control or regulation device being designed such that it operates the heating device in dependence on one or more parameters.

14. A refrigerator unit and/or a freezer unit in accordance with claim 13, wherein the parameter is the temperature at or in the region of at least one outer side of the unit.

15. A refrigerator unit and/or a freezer unit in accordance with claim 13, wherein the parameter is the difference of the temperature at or in the region of at least one outer side of the unit and the environmental temperature.

16. A refrigerator unit and/or a freezer unit in accordance with claim 13, wherein the parameter is the humidity of the air at or in the region of at least one outer side of the unit and/or the humidity of the air of the environment.

17. An arrangement comprising at least one refrigerator unit and/or freezer unit and having at least one heating device for the avoidance of condensate formation, wherein the heating device is a heating device which is not foamed in and which is arranged in the region of at least one outer side of the unit.

18. An arrangement in accordance with claim 17, wherein the heating device is arranged in the region of one or both side walls of the unit.

19. An arrangement in accordance with claim 17, wherein the heating device is a component of a modular kit which can preferably be attached subsequently in the region of the unit.

20. An arrangement in accordance with claim 17, wherein the at least one refrigerator unit and/or freezer unit is made in accordance with the heating device being an electric heater.
